(19) United States
(12) Patent Application Publication
(10) Pub. No.: US 2010/0266805 A1
(43) Pub. Date: Oct. 21, 2010

(54) LATEX COMPOSITIONS HAVING IMPROVED WASH DURABILITY AND ARTICLES CONTAINING THE SAME

(75) Inventor: Nadav Sharir, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Glenoit LLC

(21) Appl. No.: 12/728,415

(22) Filed: Mar. 22, 2010

Related U.S. Application Data
(60) Provisional application No. 61/170,469, filed on Apr. 17, 2009.

(51) Int. Cl. C08L 9/04; C08L 9/08; C08L 9/00; C08K 3/26; D04H 11/00; B05D 3/02

(52) U.S. Cl. 428/96; 524/836; 524/828; 524/832; 524/426; 523/122; 427/389.9

(57) ABSTRACT

The invention provides a latex composition having a natural latex, a synthetic latex, a filler, and certain additives. A latex composition of the invention applied to a substrate allows the finished substrate to have improved wash durability. Fabrics and products comprising the latex composition are also provided. In particular, a rug manufactured from fabrics that have been coated with the latex composition may undergo at least 100 wash cycles without sustaining any significant structural deterioration, deterioration in softness and contact absorption, and/or substantial impairment to the functionality of the applied latex composition.

### CROSS REFERENCE TO RELATED APPLICATIONS

This application claims priority to U.S. Provisional Patent Application No. 61/170,469, filed on Apr. 17, 2009, which is fully incorporated herein by reference.

### FIELD OF INVENTION

The present invention relates to a latex composition, more particularly, the invention relates to a latex composition that when applied to a substrate improves the wash durability of the finished substrate. The present invention also relates to articles of manufacture containing the latex compositions of the invention.

### BACKGROUND OF THE INVENTION

Latex-based compositions have found use in various applications including molded articles such as gloves and articles of clothing. Additionally, latex-based compositions have been applied to certain fabric substrates, such as, for example, acting as a backing or underlay for carpets and/or rugs. The latex-based backing may provide several advantageous properties including improved strength and durability as well as a higher coefficient of friction to provide greater resistance to movement against surfaces in which the article of manufacture comes in contact. However, conventional latex-based compositions used in these types of applications limits the number of wash, rinse, and drying cycles the fabric article may be capable of enduring.

There remains a need in the art for a latex-based composition that has improved washability and a high degree of wash durability such that, after undergoing a multiplicity of wash cycles, the structural integrity of the fabric article to which the latex composition is applied and the advantageous properties imparted to the latex-based substrate remain substantially in tact.

Articles that use natural latex-based compounds may have various desirable properties including resisting permanent substantial elongation even under constant stress (resistance to creep); an ability to return to its original form and size after undergoing various compressive stresses (compression resistance); elasticity; resistance to various chemicals including solvents; and biocompatibility. However, the properties imparted by the use of compositions having only natural latex may be inconsistent due to the variability in the sources that supply natural latex. Additionally, many users have been found to be allergic natural latex-based products.

Largely in response some of the disadvantages associated with the use of natural latex in products, artificial or synthetic latex compounds have been developed. However, many of the synthetic latex materials tend to be more expensive than natural latex materials and, in some cases, may demonstrate physical, mechanical, and chemical properties that are inferior to those of natural latex. Nonetheless, in some articles of manufacture, it has been found that the amounts of natural latex and synthetic latex may be proportioned to impart the desired physical, mechanical, and chemical properties to the latex-based substrate. For example, a base latex composition comprising 30% of a natural latex rubber; 4.2% of a synthetic latex, such as, styrene butadiene rubber; and 65.8% filler, such as a limestone, which is typically added to reduce the overall cost associated with the latex-based composition, may serve as a backing for a fabric substrate, such as a rug or fabric used in upholstering. This latex-based composition imparts the desired level of frictional resistance to the fabric without substantially compromising the softness and contact absorption required in the application where the treated fabric is used. However, a disadvantage of conventional latex-based compositions are their inability to sustain a number of washing and drying cycles, which may be necessary depending upon the intended use of the fabric article, without compromising the structural integrity of the fabric while substantially maintaining the advantageous properties imparted by the applied latex composition.

There continues to remain a need in the art for a latex composition that may be used in manufacturing an article, such as a fabric article, that can withstand a large number of washing, rinsing, and drying, or launderable, cycles, without substantially impacting the structural integrity of the article and the properties imparted by the latex-based substrate.

### BRIEF SUMMARY OF THE INVENTION

Without intending to be bound by theory or functionality, the present invention addresses the deficiencies of prior art latex compositions as applied to washable substrates and provides a latex composition that when applied to a washable substrate, such as a fabric, enhances the wash durability of the substrate over similar washable substrates comprising latex compositions known in the prior art.

In one aspect, the invention provides a latex composition that is applied to a washable substrate to impart a wash durability to the washable substrate comprising from about 38 wt % to about 50 wt % of a natural latex, from about 3 wt % to about 4 wt % of a synthetic latex, and from about 47 wt % to about 58 wt % of a filler, all based on the total weight of the latex composition on an additive free basis. A washable substrate having the latex composition applied thereto may undergo a multiplicity of wash cycles, for example, a wash cycle under temperature, detergent solution, bleaching, and abrasive action conditions according to AATCC 61 wash test standard 2A for laundering, without substantially changing the structural integrity of the substrate. In an embodiment of the invention, the washable substrate having the latex composition applied thereto substantially maintains its structural integrity after undergoing at least about 50 wash cycles. In another embodiment of the invention, the washable substrate having the latex composition applied thereto substantially maintains its structural integrity after undergoing at least about 100 wash cycles.

Structural integrity may be any one of or any combination of appearance, size, shape, resilience, strength, stretch-ability, yield-ability, color fastness, resistance to pilling, and lack of undue pilling such that the substrate remains suitable to use for its intended purpose. In an embodiment of the invention, structural integrity is defined by the strength of the substrate as measured by, for example, any test commonly used to measure a property related to the strength of a substrate or fabric.

According to one embodiment of the invention, the synthetic latex may comprise any one or more of styrene-butadiene rubber, acrylonitrile-butadiene rubber, methyl methacrylatebutadiene rubber, and an acrylic latex. Specifically, a synthetic latex may comprise a styrene-butadiene copolymer having an average molar ratio of butadiene monomer relative to the styrene monomer in a range of from about 1:3 to about 10:1. In certain embodiments of the invention, the filler comprises a limestone.

The latex composition may be an admixture additionally comprising an additive. One or more additives may be included in the latex composition to impart one or any number of functionalities to the latex composition including any of an accelerator, a stabilizer, an anti-aging substance, a viscosity regulator, a pour point depressant, a pigment, a leveling agent, a flatting agent, a dispersing agent, an ultraviolet absorber, an anti-settling agent, an anti-skinning agent, an anti-floating agent, an antimicrobial agent, a corrosion inhibitor, a thickening agent, a gelling agent, a coalescing agent, a lubricating agent, a defoaming agent, a coagulant, a fire-retardant, and any combination thereof.

In one aspect, the invention provides a launderable rug having a fabric substrate and a latex composition applied to the fabric substrate, the latex composition imparting a wash durability to the rug, the latex composition comprising, by weight of the latex composition on an additive free basis, from about 38 wt % to about 50 wt % of a natural latex, from about 3 wt % to about 4 wt % of a synthetic latex, and from about 47 wt % to about 58 wt % of a filler. The structural integrity of the finished rug having the latex composition applied thereto remains substantially unchanged after undergoing a multiplicity of wash cycles, in some embodiments of the invention, having the ability to undergo at least about 50 wash cycles, and, in other embodiments of the invention, having the ability to undergo at least about 100 wash cycles.

The fabric substrate of the rug may comprise a cotton fiber, a polyester fiber, a polyamide fiber, a polyethylene fiber, a polypropylene fiber, and any combination thereof. In a preferred embodiment, the fabric substrate substantially comprises a polypropylene fiber. In certain embodiments of the invention, the fabric substrate may be one or more of tufted, needle-punched, bonded pile, woven, knitted, and nonwoven. In certain embodiments of the invention, the fabric substrate at least comprises a tufted material that is at least one of a tufted cut-pile, a tufted loop-pile, a tufted multi-level pile, and a tufted combination of loop and cut pile.

In another aspect, the invention provides a method of making a finished fabric having a high wash durability, for example, the finished fabric has the ability to undergo at least about 25 wash cycles, at least about 50 wash cycles, and at least about 100 wash cycles without sustaining any significant structural deterioration and/or impairing the functionality of the applied latex composition, comprising the steps of providing a latex composition comprising, on an additive free basis, from about 38% to about 50% by weight of a natural latex, from about 3% to about 4% by weight of a synthetic latex, and from about 47% to about 58% by weight of a filler; applying the latex composition to a fabric substrate; and curing the latex composition thereby forming a substantially adherent residue across the fabric substrate.

In an embodiment of the invention, the finished fabric may undergo at least about 50 wash cycles without at least one of substantially changing a structural integrity of the finished fabric, substantially deteriorating a softness and contact absorption of the finished fabric, and substantially impairing the applied latex composition from imparting a wash durability to the rug. In another embodiment of the invention, the finished fabric may undergo at least about 100 wash cycles without at least one of substantially changing a structural integrity of the finished fabric, substantially deteriorating a softness and contact absorption of the finished fabric, and substantially impairing the applied latex composition from imparting a wash durability to the rug. In an embodiment of the invention, the structural integrity of the rug is defined by a strength of the rug. In certain embodiments of the invention, the finished fabric of the method is a rug.

### DETAILED DESCRIPTION OF THE INVENTION

The present invention now will be described more fully hereinafter, in which some, but not all embodiments of the inventions are shown. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

Many modifications and other embodiments of the inventions set forth herein will come to mind to one skilled in the art to which these inventions pertain having the benefit of the teachings presented in the descriptions herein. Therefore, it is to be understood that the inventions are not to be limited to the specific embodiments disclosed and that modifications and other embodiments are intended to be included within the scope of the appended claims.

As used in the specification and in the appended claims, the singular forms “a”, “an”, and “the” include plural referents unless the context clearly indicates otherwise. For example, reference to “a latex” includes a plurality of such latexes.

The present invention provides a latex composition that is applied to a substrate resulting in an increase in the wash durability of the coated substrate. Fabrics comprising the latex compositions of the invention are further provided. The invention also provides a variety of articles of manufacture that contain the latex composition disposed onto fabrics as further described herein. A specific embodiment of the invention is directed to a rug comprising a fabric substrate and a latex composition, as further described herein, disposed thereon.

The present invention provides improvements over latex compositions known in the art and substrates upon which the inventive latex compositions have been applied by providing an improved wash durability over the prior art compositions. Wash durability means, in part, the ability to substantially maintain the structural integrity of the finished substrate that has been treated with the latex composition even after being subjected to a number of wash cycles.

The inventive latex composition is useful in a variety of products of manufacture that incorporate fabrics and fibers as described herein including rugs, particularly rugs that, due to their requisite use, may require a multiplicity of washings over their useful lifetimes. Indeed, an improvement in wash durability can be expected to improve the useful lifetimes of such rugs.

Not intending to be limiting, synthetic latexes are typically characterized by high pigment bonding capacity, uniform quality, and good adhesion to substrates in comparison to natural latexes. Notwithstanding these advantageous properties, which are well-known in the art, the inventor has discovered that by increasing the amount of natural latex in a latex composition, offsetting, in part, the amount of synthetic latex, allows a substrate coated with the invention latex compositions to have improved washability and wash durability over other latex compositions known in the art. For example, a substrate having a backing comprising the inventive composition experiences an order of magnitude improvement in the number of wash cycles the substrate is capable of sustaining without compromising the structural integrity and functionality of the backing material.

As used herein, the term “latex” defines a dispersed phase, comprised of particles, in a dispersion medium, the dispersion medium sometime referred to as the latex serum. The dispersion medium is typically water but may be any aqueous solution comprising any solvent. Any such other solvent is typically miscible with water. The dispersed phase may be comprised of particles, microparticles, emulsion droplets, and any combination thereof. Preferably, the dispersed phase will be uniformly distributed throughout the dispersion medium.

The term “natural latex,” as used herein, defines a latex comprising a dispersed phase that at least includes small particles of rubber that are derived from certain species of trees, shrubs, and plants, such as, for example, any variety of rubber tree. Natural latex is sometimes a white, tacky, aqueous dispersion of a complex hydrocarbon polymer mix. Natural latex that is dried possesses certain inherent cohesive properties. This definition, however, should not be considered limiting. The term “natural latex” is intended to cover any of the natural latexes further disclosed herein as well as any other natural latex known in the art.

The term “synthetic latex,” as used herein, defines a latex comprising a dispersed phase that at least comprises a synthesized polymer. Without intending to be limiting, synthetic latex is generally made from an emulsion polymerization technique. The polymer particles typically have size ranges varying from about 0.05 microns to about 0.15 microns, but may be varied by the conditions under which the emulsion polymerization is performed. This definition, however, should not be considered limiting. The term “synthetic latex” is intended to cover any of the synthetic latexes further disclosed herein as well as any other synthetic latex known in the art that may be suitable for use in the latex compositions of the invention.

As used herein, the term “wash cycle” means undergoing at least a wash sequence and typically includes a rinse sequence but may also include a drying sequence. Under certain circumstances a wash cycle may include laundering an article in a standard washing machine using the suggested amounts of a commercially available detergent. A wash cycle whereby the article is laundered may be a standard washing machine that typically encounters the following steps: water fill, wash cycle mild agitation, water draining, spin cycle, rinse water fill, rinse cycle with mild agitation, water draining, and a final spin cycle. In an embodiment of the invention, a wash cycle is under temperature, detergent solution, bleaching, and abrasive action conditions according to AATCC (American Association of Textile Chemists and Colorists) 61 wash test standard 2A for laundering.

The article may be air dried or subjected to a drying process, such as, for example, with the use of a standard dryer. It is intended that a standard dryer will be operated at a temperature that is below the melting temperature of the cured latex composition that has been applied, for example, a temperature typically encountered on a low heat setting for the dryer.

The use of the term “wash cycle” generally is not intended to include applying the most rigorous wash and/or drying cycles, nor is the use of the term intended to include the gentlest application of a wash and/or drying cycle. A wash cycle is to be conducted with the necessary degree of mechanical treatment needed to substantially rid the article of dirt and other foreign materials routinely encountered through common household use.

The term “additive free basis,” as used herein, is intended to mean the weight of a latex composition prior to the addition of any additives. In other words, the weight of a latex composition on an additive free basis is the weight of the latex composition that is substantially free of any additives. However, such additives are not intended to include any additives that may typically be found in a prepared natural latex, synthetic latex, or filler used in the basic latex composition formulation unless such additives are specifically disclosed herein.

As used herein, the term “structural integrity” is intended to have its broadest interpretation when describing a substrate. Without intending to be limiting, structural integrity may mean the substrate retains any of, as well as any combination of, appearance, size, shape, resilience, strength, stretch-ability, yield-ability, color fastness, resistance to pilling, lack of undue pilling, etc. such that the substrate remains suitable to use for its intended purpose.

As used herein, the terms “substantially maintains”, “substantially unchanged”, “substantially in tact”, “substantially impairing”, and the like, as used interchangeably herein, refers to a change of less than about 30%, preferably less than about 20%, and more preferably less than about 10% in a referent or related property.

The latex composition may be comprised of a natural latex, a synthetic latex, a filler, and combinations thereof. The latex composition may additionally comprise one or more additives, as further disclosed herein.

The natural latex may be a latex derived from a plant. For example, rubber trees are a popular source of natural latex. Natural latexes derived from plants are complex emulsions comprised of many different types of compounds in varying concentrations, typically dependent upon the species of plant from which they are derived. However, as understood by a person of ordinary skill, the types and concentration of compounds in natural latex will also be influenced by other factors, even for the same variety of plants, such as, for example, regions where the plants are grown, growing and cultivation conditions, etc. Natural latexes may, individually or any combination, include proteins, resins, gums, sugars, starches, oils, and alkaloids, which are intended to be exemplary and not limiting.

Optionally, the natural latex may be in a concentrated form. In certain embodiments of the invention, the natural latex may have been subjected to additional treatments that include, for example, but are not limited to, purification, coagulation, preservation, and vulcanization. The concentration of solids in natural latex may vary from about 30% to about 75% by weight based on the total weight of the natural latex. The concentration of solids may be affected by additional treatment techniques, if any, to which the natural latex may be exposed. For example, in certain embodiments of the invention, water may be additionally included in the latex composition resulting in effectively decreasing the concentration of solids in the natural latex composition. In yet other embodiments, the natural latex may be exposed to a treatment process that removes a portion of the dispersion medium resulting in effectively increasing the concentration of solids in the natural latex composition.

A synthetic latex is typically a polymer or plastic latex. The synthetic latex may be comprised of homopolymers, such as, for example, homopolymers of vinyl acetate, acrylates, and vinyl chloride. In certain embodiments of the invention, the synthetic latex is comprised of a copolymer, such as, for example copolymers of styrene and butadiene or of vinyl acetate, acrylates, and vinyl chloride. In an embodiment of the invention, the synthetic latex is comprised of any diene rubber polymers, preferably copolymerized diene rubber polymers.

In certain embodiments of the invention, the synthetic latex may be selected from any of styrene-butadiene rubber, acrylonitrile-butadiene rubber, methyl methacrylatebutadiene rubber, an acrylic latex, and combinations thereof. In an embodiment of the invention, the synthetic latex comprises a polymer selected from the group consisting of butyl rubber; polybutadiene; styrene-butadiene copolymer; 3,4-polyisoprene; cis-1,4-polyisoprene; styrene-isoprene copolymer; styrene-isoprene-butadiene terpolymer; and any combination thereof.

In a preferred embodiment of the invention the polymer of the synthetic latex comprises a styrene-butadiene copolymer. In an embodiment of the invention, the average molar ratio of the butadiene monomer relative to the styrene monomer constituting the styrene-butadiene copolymer is in a range of from about 1:3 to about 10:1.

In certain embodiments of the invention, the filler may include a solid, for example a powder; a liquid, for example, a resin; and any combination thereof. In an embodiment of the invention, the filler is calcium carbonate or any similar material. In certain embodiments of the invention, the filler is at least one of calcium carbonate, zinc carbonate, calcium silicate, aluminum silicate, magnesium silicate, sodium silicate, silicic acid, silica, calcium sulfate, barium sulfate, titanium oxide, zinc oxide, and alumina. Other examples of fillers that may be useful in the invention include talc, fiberglass, barites, fly ash, kaolin, rubber crumb, and other inorganic materials and minerals. In another embodiment of the invention, the filler is a calcium carbonate containing material. In a preferred embodiment of the invention, the filler is a limestone. Of course, any combination of fillers herein mentioned or otherwise known in the art may also be used in the latex composition.

In certain embodiments of the invention, it may be useful to use a filler that is comprised of a flame retardant material. Nonlimiting examples of such flame retardant materials that may be used fully or in part as the filler include magnesium hydroxide and aluminum trihydrate.

The latex compositions may be an admixture having any number of standard compounding additives, such as accelerators, stabilizers, anti-aging substances, viscosity regulators, pour point depressants, and pigments. The admixture may also include leveling and rheology agents such as silicones, fluorocarbons, and cellulosics; flatting agents; pigment wetting and dispersing agents including surfactants; ultraviolet absorbers; tinting pigments; anti-settling, anti-sag and bodying agents; anti-skinning agents; anti-flooding and anti-floating agents; fungicides and mildewcides; corrosion inhibitors; thickening and/or forming agents; or coalescing agents. The admixture may additionally include processing-based additives such as, for example, lubricants, lubricating agents, and flow control agents such as any wax, silicone, metallic soaps, fatty acids, amines, and amides, and combinations thereof; defoaming and antifoaming agents; and coagulants.

In certain embodiments of the invention, the latex composition may comprise an additive that causes the composition to gel, i.e., by using a gel or gelling agent or gellant. Such a latex composition may be termed a “latex gel.” A gel, gelling agent, or gellant is an additive that causes the composition to form a jelly-like solution and demonstrate both solid-like and solution-like properties. Typically, in suspensions of polymers, such as latex compositions, gelling can be caused by polymer entanglements due to physical bonding—a physical gel—or by polymer entanglements due to chemical bonding—a chemical gel. The types of bonds that form in the suspension may be dependent upon the type of gel or gelling additive or gellant used. These entanglements cause a network of aggregates to form among the dispersed phase allowing the dispersion medium to become disposed there between. Non-limiting examples of gel agents include zinc salts, chlorides, fluorides, sulfur-containing compounds, and acetates. A preferred latex composition uses zinc chloride as a gel or gelling agent.

Various factors may be determinative of the amount, if any, of gelling agent that is used in the latex composition. For example, the amount of gelling agent may be determinative of the extent of gelling that occurs over a certain period of time. Depending of the selection of the gellant, an increase in the amount of agent used may decrease the amount of time to achieve a requisite extent of gelling that occurs in the latex composition. Typically, concentrations of gels may range from about 0.2 parts to about 6.5 parts per hundred parts of the latex composition on an additive free basis.

The admixture may additionally comprise an accelerator. Accelerators generally refer to additives that speed up a chemical reaction. Specifically, an accelerator may be used to accelerate the polymerization and/or crosslinking among the species present in the dispersed phases of the natural latex and the synthetic latex. Without intending to be bound by theory, such activity of an accelerator will reduce the amount of curing time needed after the latex composition has been applied to a substrate. Accelerators may include, but are not limited to, any metallic salt that can provide acidic cations which may induce polymerization, such as, for example, cobalt, vanadium, and manganese salts of naphthenic acid and salts of N-substituted dithio carbamic acid. Other nonlimiting examples of accelerators include certain metallic soaps; a class of accelerators typically used as vulcanization accelerators, such as, for example, the zinc salts of dialkyl dithio carbamates including zinc butyl ethyl dithiocarbamote, zinc diethyl dithiocarbiamate, zinc dibutyl dithiocarbamate, and zinc dimethyl dithiocarbamate, zinc meraptobenthiazole, and diphylguianidine; dimethylaminopyridine; tris (dimethylaminomethyl) phenol; metal alkyl xanthates; thiazoles; thiurams; imidazole or imidazole derivatives such as salts, substituted imidazoles or metal complexes thereof. Any combination of accelerators may also be included in the admixture.

Another useful additive that may assist with curing a latex composition that has been applied to a substrate includes a thickener. Thickeners may also be used to facilitate good spreading, handling, and application characteristics of the latex composition admixtures, in particular for the latex compositions of the invention used for coating a substrate. Thickeners useful in the inventive composition may include synthetic thickeners, such as, acrylic-based polymers derived from acrylic acid or acrylate esters; ammonium polyacrylate; and polyvinyl alcohol. Natural thickeners may also serve as thickeners, such as, casein, xanthan gum, gum tragacanth, alginates, and modified celluloses. Examples of modified celluloses include, but are not limited to, methyl cellulose, hydroxyethyl cellulose, hydroxypropyl cellulose and carbomethoxy cellulose. Thickening agents useful in the latex composition admixtures may include any individual thickening compound or combination of thickening compounds.

Pigments may also be compounded into the latex composition admixture. Non-limiting examples of pigments include white opacifying pigments, e.g., titanium dioxides including rutile titanium dioxide, titanium white, lithopone, zinc sulfide, lead titanate, antimony oxide, zirconium oxide, barium sulfide, and zinc oxide; colored organic pigments, e.g., permanent red, phthalocyanine blue, phthalocyanine green, and hansa yellow; and inorganic pigments, e.g., red iron oxide, brown oxide, umbers, and ochres. Any combination of pigments may be used. A preferred combination of compounds providing a blue pigment includes one that is derived from royal GL pigment available from Astron that is substantially free of a titanium dioxide. Other exemplary blue pigments include Graphthol Blue 2GLS, Sandorin Blue RL and Sandorin Blue 91052 manufactured by Clariant Co., Ltd.; Lutetiacyanine CSN manufactured by ICI Ltd.; Palomar Blue B4806 and Palomar Blue B4707 manufactured by Mobay Co., Ltd.; and Heliogen Blue L6920, Heliogen Blue L6875F, Heliogen Blue L6901F, Heliogen Blue L6905F, Heliogen Blue L6975F, Heliogen Blue L6989F, Heliogen Blue L7072D, Heliogen Blue L7080, Heliogen Blue L7101F and Heliogen Blue L6700F manufactured by BASF AG.

Additives may also include one or more surfactants. Surfactants may help the dispersed phases to become more evenly distributed throughout the latex composition and act as stabilizers for the admixture. Surfactants that assist with the distribution of the dispersed phase throughout the dispersion medium may also be known as emulsifiers. Anionic and/or nonionic surfactants may be useful in the latex compositions of the invention. Nonlimiting examples of anionic surfactants include sulfates, e.g., sodium lauryl sulfate; sulfated natural oils and esters; acyl derivatives of sarcosine, e.g., methyl glycine; alkyl aryl polyether sulfates; alkali alkyl sulfates; ethoxylated aryl sulfonic acid salts; certain sulfonates, such as, alkyl aryl polyether sulfonates and isopropyl naphthalene sulfonates; sulfosuccinates; phosphate esters, e.g., the short chain fatty alcohol partial esters of complex phosphates; orthophosphate esters of polyethoxylated fatty alcohols; and certain carboxylates such as fatty acid soaps from lauric, stearic, and oleic acid. Typical nonlimiting examples of nonionic surfactants include mono- and polyhydric alcohols; certain ethylene oxide derivatives, e.g., ethoxylated alkyl aryl derivatives; ethylene oxide and propylene oxide block copolymers; esters; amines; products of the dehydration of sorbitol such as sorbitan monostearate and polyethylene oxide sorbitan monolaurate; and lauric acid. Concentrations of surfactants, if included, may range from about 0.01 to about 3 parts, preferably, from about 0.1 to about 2 parts, per hundred parts latex composition on an additive free basis.

In certain embodiments of the invention, the admixture may additionally comprise adhesives or adhesion promoters to enhance the strength of adhesion between the latex composition and the substrate. Further to this embodiment, adhesive promoters may have a concentration from about 0.15 parts to about 3.5 parts per hundred parts of the latex composition on an additive free basis. In certain embodiments of the invention, the adhesive or adhesion promoter may be first applied to the substrate prior to coating the substrate with the latex composition in order to strengthen the bond between the substrate and the components of the latex composition.

Antimicrobial additives that help to control mold and mildew growth, particularly in wet environments, may be useful in certain embodiments of the invention. The concentration of such antimicrobial additives range from about 0 to about 10 parts per hundred parts latex composition on an additive free basis. Scent or odor eliminators may also be added to the latex composition admixtures. The concentration of such additives may be from about 0 to about 20 parts per hundred parts latex composition on an additive free basis.

In an embodiment of the invention, the latex composition comprises a natural latex having a concentration of from about 38 wt % to about 50 wt %, from about 38 wt % to about 45 wt %, from about 38 wt % to about 42 wt %, and from about 38 wt % to about 40 wt %, all based on the weight of the latex composition on an additive free basis.

In an embodiment of the invention, the latex composition comprises a synthetic latex having a concentration of from about 3 wt % to about 4 wt %, from about 3.2 wt % to about 4 wt %, from about 3.5 wt % to about 3.9 wt %, and from about 3.6 wt % to about 3.8 wt %, all based on the weight of the latex composition on an additive free basis.

In an embodiment of the invention, the latex composition comprises a filler having a concentration of from about 47 wt % to about 58 wt %, from about 49 wt % to about 58 wt %, from about 52 wt % to about 58 wt %, and from about 56 wt % to about 58 wt %, all based on the weight of the latex composition on an additive free basis.

In an exemplary embodiment, the latex composition comprises about 39 wt % of a natural latex, about 3.7 wt % of a synthetic latex comprising a styrene butadiene rubber, and about 57.3 wt % of a limestone filler, all based on the weight of the latex composition on an additive free basis.

In an embodiment of the invention, the latex composition is an admixture including one or more of the types of additives as further disclosed herein having a concentration of from about 3 parts to about 40 parts per hundred parts of the latex composition on an additive free basis.

In accordance with certain embodiments of the invention, the natural latex, the synthetic latex, the filler, and, optionally, the one or more additives are mixed and coagulated to form the composition that is applied to a substrate. For example, the latex compositions of the invention may be applied to a substrate by one or more of immersion, any extrusion process including co-extrusion, deposition, spraying, dip coating, slot coating, spray coating, roller coating, brush coating, spin coating, wire bar coating, doctor blade coating, flow coating, suffusion coating, emulsion coating, and pad coating. Indeed any process known in the art for applying a composition to a substrate may be used to apply the latex compositions of the invention in a likewise manner.

In an embodiment of the invention, the surface of the substrate preferably has a substantial affinity for the latex composition. Optionally, another compound may be applied to the substrate that is capable of allowing the latex composition to become adhered to a surface of the substrate. For example, a hydrophilic substance, many of which are well-known in the art, preferably hydrophilic compounds that are compatible with the latex composition, may be applied to the substrate in order to impart to the surface of the substrate with an affinity for the latex composition. As described herein, an adhesive may be used strengthen the bond that forms between the substrate and the latex composition applied thereon.

Once the latex composition is applied to the substrate, it must be allowed a sufficient amount of time to cure. As used herein, the term “cure” is defined by the release of the water and any other solvent that makes up the dispersion medium and the formation of bonds between the components of the dispersed phase that allows the final cured latex composition to form an adherent residue across the substrate. Any accelerator(s), applied heat, as well as other means known in the art may be useful to increase the rate at which the latex composition becomes cured.

A washable substrate that is prepared using the latex composition of the invention will be capable of undergoing a multiplicity of wash cycles without substantially changing the structural integrity of the substrate or substantially impairing the functionality of the applied latex composition. In an embodiment of the invention, the washable substrate undergoes at least about 5 wash cycles, at least about 10 wash cycles, at least about 20 wash cycles, at least about 25 wash cycles, at least about 50 wash cycles, at least about 75 wash cycles, at least about 90 wash cycles, and at least about 100 wash cycles without at least one of substantially changing the structural integrity of the substrate and substantially impairing the functionality of the applied latex composition.

In another aspect, the latex composition may be applied to a substrate that is a fabric. Fabrics encompassed by the present invention include, without limitation, tufted fabrics, fabrics having a needle-punched surface, a bonded pile, a woven fabric, a knit fabric, a nonwoven fabric, and any combination thereof. Tufted fabrics may be at least one of a tufted cut-pile, a tufted loop-pile, a tufted multi-level pile, and a tufted combination of loop and cut pile. The fabric may be comprised of a natural fiber, a man-made cellulosic fiber, a polyester, a polyamide, a polyethylene, a polypropylene, and any combination thereof. In a preferred embodiment of the invention, the fabric is a tufted material comprising at least one of a natural fiber of cotton, a nylon fiber, a polypropylene fiber, and any combination thereof. Even more preferred, the fabric is a tufted material comprising only a polypropylene fiber.

Fibers that are not cut, for example, filament yarns, may be formed into fabrics by knitting or weaving, optionally in combination with other yarns. Staple fibers may be spun, optionally in combination with other staple fibers, into spun yarns. These yarns can be formed into fabrics by knitting or weaving. Staple fibers, optionally in combination with other staple fibers, also may be formed into nonwoven fabrics by wet-laid processes, such as paper-forming, by air-laid processes, or by carding to form a card web that can be subsequently strengthened by any one or more of thermal bonding, chemical bonding, needlepunching, stitchbonding and hydroentangling. A tufted fabric may be manufactured on any conventional tufting machine utilizing a base sheet of woven fabric and tufting yarns.

Another aspect of the invention includes products made from the inventive fabrics and/or inventive fibers disclosed herein. In an embodiment of the invention, the product comprising the fabric as disclosed herein is provided.

The fibers can be incorporated into various fabrics, as described above, in varying amounts, depending upon the desired properties of the product manufactured from the fabric. In an embodiment of the invention, the fabric used for the substrate has a basis weight of from about 100 to about 2,000 grams per square meter (“gsm”), from about 250 to about 1,000 gsm, and from about 400 to about 1,000 gsm. In an embodiment of the invention, the fabric is a rug having a basis weight of from about 250 to about 1,000 gsm.

The amount of the latex composition of the invention applied to the fabric may also vary, depending upon the desired properties of the product manufactured from the fabric, which is sometimes determined by the intended use of the fabric. For example, without intending to be limiting, the fabric is coated with a latex composition having a coating weight of from about 600 to about 1,000 gsm and the finished fabric is intended to be used as a rug. In another embodiment of the invention, the fabric is double coated using either the same latex composition or latex compositions having distinctly different components and/or concentrations.

A washable fabric that is prepared using the latex composition of the invention will be capable of undergoing a multiplicity of wash cycles without substantially changing the structural integrity of the fabric or substantially impairing the functionality of the applied latex composition. In an embodiment of the invention, the washable fabric undergoes at least about 5 wash cycles, at least about 10 wash cycles, at least about 20 wash cycles, at least about 25 wash cycles, at least about 50 wash cycles, at least about 75 wash cycles, at least about 90 wash cycles, and at least about 100 wash cycles without at least one of substantially changing the structural integrity of the fabric and substantially impairing the functionality of the applied latex composition.

Another aspect of the invention includes a method of manufacturing a fabric having improved washability and a high wash durability. The method comprises the steps of providing a latex composition comprising, on an additive free basis, from about 38% to about 50% by weight of a natural latex, from about 3% to about 4% by weight of a synthetic latex, and from about 47% to about 58% by weight of a filler; applying the latex composition to the fabric; and curing the latex composition thereby forming a substantially continuous adherent residue across the fabric to form a finished fabric.

In an embodiment of the invention, the finished fabric manufactured according to the method disclosed herein may undergo a multiplicity of wash cycles without sustaining any significant structural deterioration and/or impairing the functionality of the applied latex composition. In certain embodiments of the invention, the finished fabric may undergo at least about 5 wash cycles, at least about 10 wash cycles, at least about 20 wash cycles, at least about 25 wash cycles, at least about 50 wash cycles, at least about 75 wash cycles, at least about 90 wash cycles, and at least about 100 wash cycles without sustaining any significant structural deterioration and/or impairing the functionality of the applied latex composition.

A high wash durability means a finished fabric of the invention may undergo a large number of wash cycles such as, for example, at least about 25 wash cycles, preferably at least about 50 wash cycles, and more preferably at least about 100 wash cycles under temperature, detergent solution, bleaching, and abrasive action conditions according to AATCC 61 wash test standard 2A for laundering without experiencing a substantial change in strength of the finished fabric in comparison to other finished fabrics known in the art that have undergone a similar number of wash cycles. For example, the strength of the finished fabric of the invention will be at least about 10%, at least about 20%, at least about 30%, preferably at least about 50%, more preferably at least about 70%, and even more preferably at least about 100% greater than the strength of other finished fabrics known in the art that have undergone a similar number of wash cycles. The strength of the finished fabric may be measured, for example, by grab tensile strength (e.g., ASTM D5034 that uses a tensile testing machine for measuring the highest tensile load achieved just before a fabric specimen tears or breaks) or tongue tear strength (e.g., ASTM D2261 that uses a tensile strength test for measuring the force required to continue a rip through a prepared fabric specimen), or any other test commonly used to measure a property related to the strength of a fabric.

In an embodiment of the invention, the latex composition may be applied to the fabric by any of immersion, deposition, coating, spraying, and combinations thereof. In certain embodiments of the invention, steam heat or other drying techniques known in the art may be used as part of the curing step. Further to these embodiments, the latex composition may be exposed to temperatures in a range of from about 360° F. to about 400° F. in order to facilitate curing.

At least one embodiment of the present invention provides a rug comprising at least one layer of a conformable fabric wherein the latex composition of the invention is applied to such conformable fabric. The finished rug generally has the ability to sustain a multiplicity of washes. In an embodiment of the invention, the rug may sustain at least about 5 wash cycles, at least about 10 wash cycles, at least about 20 wash cycles, at least about 25 wash cycles, at least about 50 wash cycles, at least about 75 wash cycles, at least about 90 wash cycles, and at least about 100 wash cycles without at least one of substantially compromising the structural integrity of the rug, substantially deteriorating the softness and contact absorption of the rug, and substantially impairing the ability of the applied latex composition to impart wash durability to the rug.

As appreciated by a person skilled in the art with the insight provided by this disclosure, the inventive fabrics of the invention may have a range of mechanical properties depending on, among other things, the composition and concentration of compounds of the latex composition, the basis weight of the fabric, the basis weight of the latex composition applied to the fabric, and the types of adhesives as well as other additives that may optionally be used in manufacturing or constructing the device.

It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the appended claims.

That which is claimed:

1. A latex composition comprising, on an additive free basis:
from about 38% to about 50% by weight of a natural latex,
from about 3% to about 4% by weight of a synthetic latex, and
from about 47% to about 58% by weight of a filler,
wherein the latex composition is applied to a washable substrate and imparts a wash durability to the washable substrate.

2. The latex composition according to claim 1, wherein a structural integrity of the washable substrate remains substantially unchanged after undergoing a multiplicity of wash cycles, the wash cycles are under a temperature, a detergent solution, a bleaching, and an abrasive action conditions according to AATCC 61 wash test standard 2A for laundering.

3. The latex composition according to claim 2, wherein the structural integrity is defined by a strength of the washable substrate.

4. The latex composition according to claim 3, wherein the strength of the washable substrate is at least about 50% greater than the strength of a substrate that has not been treated with the latex composition after undergoing the same multiplicity of wash cycles.

5. The latex composition according to claim 2, wherein the multiplicity of wash cycles is at least about 100.

6. The latex composition according to claim 1, wherein the synthetic latex is selected from the group consisting of styrene-butadiene rubber, acrylonitrile-butadiene rubber, methyl methacrylatebutadiene rubber, an acrylic latex, and any combination thereof.

7. The latex composition according to claim 1, the synthetic latex comprises a styrene-butadiene copolymer, wherein the styrene-butadiene copolymer has an average molar ratio of butadiene monomer relative to the styrene monomer in a range of from about 1:3 to about 10:1.

8. The latex composition according to claim 1, wherein the filler comprises a limestone.

9. The latex composition according to claim 1, additionally comprising an additive selected from the group consisting of an anti-aging substance, an ultraviolet absorber, an antimicrobial agent, a fire-retardant, and any combination thereof.

10. A rug comprising a fabric substrate and a latex composition applied to the substrate, the latex composition comprising, on an additive free basis:
from about 38% to about 50% by weight of a natural latex;
from about 3% to about 4% by weight of a synthetic latex; and
from about 47% to about 58% by weight of a filler.

11. The rug according to claim 10, wherein a structural integrity of the rug remains substantially unchanged after undergoing a multiplicity of wash cycles, the wash cycles are under a temperature, a detergent solution, a bleaching, and an abrasive action conditions according to AATCC 61 wash test standard 2A for laundering.

12. The rug according to claim 11, wherein the structural integrity is defined by a strength of the rug.

13. The rug according to claim 12, wherein the strength of the rug is at least about 50% greater than the strength of a rug that has not been treated with the latex composition after undergoing the same multiplicity of wash cycles.

14. The rug according to claim 11, wherein the multiplicity of wash cycles is at least about 100.

15. The rug according to claim 10, wherein the fabric substrate comprises a fiber having a material selected from the group consisting of a cotton, a polyester, a polyamide, a polyethylene, a polypropylene, and any combination thereof.

16. The rug according to claim 10, the fabric substrate is selected from the group consisting of a tufted material, a needle-punched surface, a bonded pile, a woven fabric, a knit fabric, a nonwoven fabric, and combinations thereof.

17. The rug according to claim 16, wherein the tufted material is at least one of a tufted cut-pile, a tufted loop-pile, a tufted multi-level pile, and a tufted combination of loop and cut pile.

18. A method of manufacturing a wash durable finished fabric comprising the steps of:
providing a latex composition comprising, on an additive free basis, from about 38% to about 50% by weight of a natural latex, from about 3% to about 4% by weight of a synthetic latex, and from about 47% to about 58% by weight of a filler;
applying the latex composition to a fabric substrate; and
curing the latex composition thereby forming a substantially continuous adherent residue across the fabric substrate.

19. The method according to claim 18, wherein the wash durable finished fabric may undergo at least about 100 wash cycles without at least one of substantially changing a structural integrity of the finished fabric, substantially deteriorating a softness and contact absorption of the finished fabric, and substantially impairing the applied latex composition from imparting a wash durability to the rug.

20. The method according to claim 18, wherein the wash durable finished fabric is a rug.
